(19) United States
(12) Patent Application Publication
(10) Pub. No.: US 2023/0065733 A1
(43) Pub. Date: Mar. 2, 2023

(54) CALCULATOR AND CALCULATION METHOD

(71) Applicant: FUJITSU LIMITED, Kawasaki-shi (JP)

(72) Inventor: Hiroshi Nakao, Yamato (JP)

(73) Assignee: FUJITSU LIMITED, Kawasaki-shi (JP)

(21) Appl. No.: 17/751,880

(22) Filed: May 24, 2022

(30) Foreign Application Priority Data
Aug. 24, 2021 (JP) 2021-136048

(51) Int. Cl. G06F 9/30; G06F 7/02; G06F 7/535; G06F 7/78

(52) U.S. Cl. CPC G06F 9/3012; G06F 7/02; G06F 7/535; G06F 7/78

(57) ABSTRACT

A calculator includes: registers each including sub-registers that hold pieces of data for use in operation; an operator that executes, in parallel, operations of the pieces of data; and a memory configured to hold a first vector and second vectors to be compared with the first vector. Each second vector is divided into sub-vectors and sub-vector groups each including the sub-vectors of the second vectors are arranged in units of sub-vector groups. A first process of transferring one of sub-vectors of the first vector to sub-registers of a first register among the registers, a second process of transferring the sub-vector group of the second vectors corresponding to the transferred sub-vector of the first vector to sub-registers of a second register, the sub-vector group being held in the memory, and a third process of calculating and integrating numbers of mismatches between bit values of the sub-vectors held are repeatedly executed.

### CROSS-REFERENCE TO RELATED APPLICATION

This application is based upon and claims the benefit of priority of the prior Japanese Patent Application No. 2021-136048, filed on Aug. 24, 2021, the entire contents of which are incorporated herein by reference.

### FIELD

The embodiments discussed herein are related to a calculator and a calculation method.

### BACKGROUND

An operation processing device that supports a single instruction multiple data (SIMD) operation instruction for processing a plurality of pieces of data in parallel by one instruction has been known. For example, in this type of operation processing device, a plurality of sets of data are collectively read from a memory matrix, operations are executed in parallel by a plurality of operators, and a plurality of sets of operation result data are collectively written to the memory matrix. This type of operation processing device includes a circuit that sets a condition flag register when all comparison operation results executed by using a register for an SIMD operation are the same.

Japanese Laid-open Patent Publication No. 2018-156119, Japanese Laid-open Patent Publication No. 2004-118470, U.S. Pat. No. 7,788,468, and 8,200,940 are disclosed as related art.

### SUMMARY

According to an aspect of the embodiments, a calculator includes: a plurality of registers each including a plurality of sub-registers that hold a plurality of pieces of data for use in operation, respectively; an operator that executes, in parallel, operations of the pieces of data held in the plurality of sub-registers, respectively; and a memory that is configured to hold a first vector and a plurality of second vectors to be compared with the first vector. Each of the plurality of second vectors is divided into sub-vectors each having a size equal to a size of each of the sub-registers, and a plurality of sub-vector groups each including the sub-vectors of the plurality of second vectors are sequentially arranged in a readable manner in the memory in units of sub-vector groups. A first process of transferring one of sub-vectors of the first vector held in the memory to a plurality of sub-registers of a first register among the plurality of registers, a second process of transferring the sub-vector group of the plurality of second vectors corresponding to the transferred sub-vector of the first vector to a plurality of sub-registers of a second register among the plurality of registers, the sub-vector group being held in the memory, and a third process of calculating and integrating numbers of mismatches between bit values of the sub-vectors held in the sub-registers corresponding to each other in the first register and the second register are repeatedly executed for all sub-vectors of the first vector. A second vector in which an integrated value of the calculated numbers of mismatches is smallest is determined to be a closest matching vector.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a calculator according to an embodiment;

FIG. 2 is an explanatory diagram illustrating an example of an action of the calculator in FIG. 1;

FIG. 3 is a block diagram illustrating an example of a calculator according to another embodiment;

FIG. 4 is an explanatory diagram illustrating an overview of search for a closest matching vector by the calculator in FIG. 3;

FIG. 5 is an explanatory diagram illustrating an example of an SIMD register and data held in a data memory area in FIG. 3;

FIG. 6 is an explanatory diagram illustrating an example in which the closest matching vector is searched by the calculator in FIG. 3;

FIG. 7 is an explanatory diagram illustrating a continuation of the search for the closest matching vector in FIG. 6;

FIG. 8 is an explanatory diagram illustrating a continuation of the search for the closest matching vector in FIG. 7;

FIG. 9 is an explanatory diagram illustrating a continuation of the search for the closest matching vector in FIG. 8;

FIG. 10 is an explanatory diagram illustrating another example of data held in the data memory area in FIG. 3;

FIG. 11 is an explanatory diagram illustrating an example in which the closest matching vector is searched by using data of an array in FIG. 10;

FIG. 12 is an explanatory diagram illustrating an example in which a sum sum(i) in Equation (1) in FIG. 11 is calculated;

FIG. 13 is an explanatory diagram illustrating an example in which a minimum value of total sums S(0) to S(7) obtained by Equation (1) in FIG. 11 is calculated;

FIG. 14 is an explanatory diagram illustrating an example in which an information vector corresponding to the minimum number of different bits calculated in FIG. 13 is searched;

FIG. 15 is an explanatory diagram illustrating an adjustment example in a case where a vector length is variable in a calculator according to another embodiment;

FIG. 16 is an explanatory diagram illustrating an example in which data having an adjusted vector length in FIG. 15 is stored in a data memory area; and

FIG. 17 is an explanatory diagram illustrating an example in which an information vector is updated in a calculator according to another embodiment.

### DESCRIPTION OF EMBODIMENTS

When a plurality of different pieces of data are processed in parallel by a plurality of threads executing an identical program, the plurality of threads wait for execution of a next process until a process of each thread is ended by a synchronization hard barrier. A multi-thread computer that executes a contraction manipulation by SIMD includes a crossbar that replaces lanes for use in threads and a crossbar controller that controls the crossbar.

Incidentally, when a closest matching vector closest to a seed vector is searched from a plurality of information vectors, for example, a calculator compares a bit value of each element of the seed vector with a bit value of each element of one information vector, and integrates numbers of elements having different bit values. For each of the plurality of information vectors, the calculator executes the comparison of the bit values and the integration of the numbers of elements having different bit values. The calculator determines the information vector having the smallest integrated value as the closest matching vector.

When the numbers of elements having different bit values are calculated for the seed vector for every information vectors by using SIMD registers, the calculator adds partial integrated values held in a plurality of sub-registers in the SIMD register between the sub-registers. However, the number of clock cycles taken for the addition between the sub-registers in the SIMD register is larger than the number of clock cycles taken for addition of the sub-registers between the SIMD registers. Thus, a method for searching for the closest matching vector in which the partial integrated values held in the plurality of sub-registers in the SIMD register are added between the sub-registers has low operation efficiency and a long search time.

According to one aspect, an object of the present disclosure is to improve search efficiency for a closest matching vector by minimizing an addition process between sub-registers in a register.

Hereinafter, embodiments will be described with reference to the drawings.

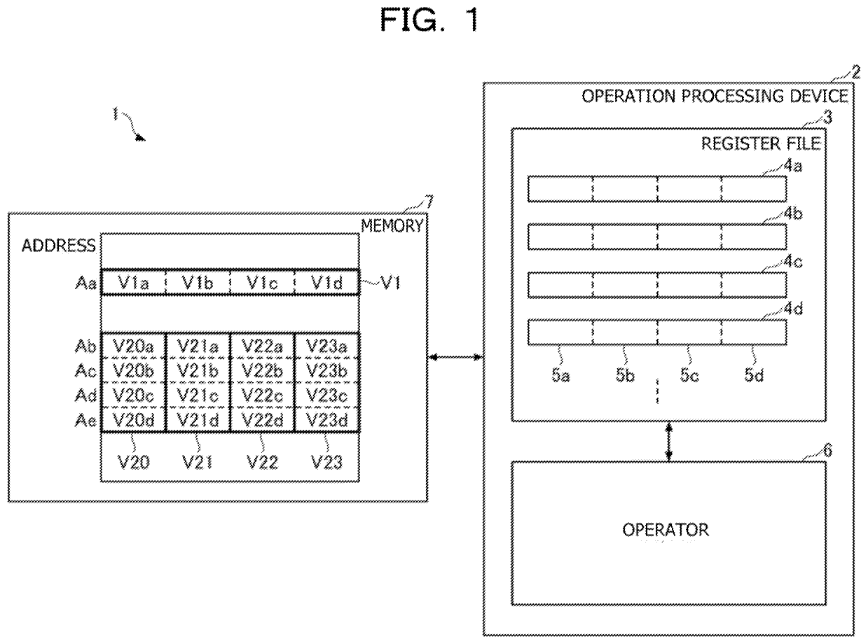

FIG. 1 illustrates an example of a calculator according to an embodiment. A calculator 1 illustrated in FIG. 1 includes an operation processing device 2 and a memory 7. For example, the operation processing device 2 is a processor capable of executing a plurality of product-sum operations or the like in parallel by using a SIMD operation instruction. The operation processing device 2 includes a register file 3 including a plurality of SIMD registers 4 (4a, 4b, 4c, 4d, . . . ) and an operator 6. Each of the SIMD registers 4 includes a plurality of sub-registers 5 (5a, 5b, 5c, and 5d) in which pieces of operation target data are stored, respectively. Although four sub-registers 5 are allocated to each SIMD register 4 in FIG. 1, the number of sub-registers 5 allocated to each SIMD register 4 varies depending on a type of the SIMD operation instruction. Hereinafter, the SIMD register 4 is also simply referred to as a register.

For example, the operator 6 executes an arithmetic operation (addition, multiplication, or the like) of data held in the sub-register 5 between the registers 4 based on an SIMD operation instruction input to the operation processing device 2. Based on the SIMD operation instruction, the operator 6 executes a logical operation (AND, OR, exclusive OR, or the like) on the data held in each sub-register 5 in the register 4.

The memory 7 has a storage area for holding a seed vector V1 and a plurality of information vectors V20, V21, V22, and V23. Although vector lengths (bit lengths) of the seed vector V1 and an information vector V2 are equal to a bit width of the register 4 in the example illustrated in FIG. 1, the vector lengths may be larger than the bit width of the register 4. Hereinafter, in a case where the information vectors V20, V21, V22, and V23 are described without being distinguished from each other, these information vectors are also referred to as the information vectors V2. The seed vector V1 is an example of a first vector, and each of the information vectors V2 is an example of a second vector.

The seed vector V1 includes pieces of data V1a, V1b, V1c, and V1d each having a size (bit width) equal to a size of the sub-register 5. Each of the pieces of data V1a, V1b, V1c, and V1d is an example of a sub-vector.

The information vector V20 includes pieces of data V20a, V20b, V20c, and V20d divided to each have a size equal to the size of the sub-register 5. The information vector V21 includes pieces of data V21a, V21b, V21c, and V21d divided to each have a size equal to the size of the sub-register 5. The information vector V22 includes pieces of data V22a, V22b, V22c, and V22d divided to each have a size equal to the size of the sub-register 5. The information vector V23 includes pieces of data V23a, V23b, V23c, and V23d divided to each have a size equal to the size of the sub-register 5. Each of the pieces of data V20a to V20d, V21a to V21d, V22a to V22d, and V23a to V23d is an example of a sub-vector.

For example, the calculator 1 arranges the seed vector V1 and the information vectors V2 received from the outside of the calculator 1 in the memory 7. The calculator 1 arranges the seed vector V1 in an area where addresses are consecutive in the memory 7. The calculator 1 arranges the pieces of data V20a, V21a, V22a, and V23a of the information vectors V20 to V23 in an area where addresses are consecutive in the memory 7. The calculator 1 arranges the pieces of data V20b, V21b, V22b, and V23b of the information vectors V20 to V23 in an area where addresses are consecutive in the memory 7.

The calculator 1 arranges the pieces of data V20c, V21c, V22c, and V23c of the information vectors V20 to V23 in an area where addresses are consecutive in the memory 7. The calculator 1 arranges the pieces of data V20d, V21d, V22d, and V23d of the information vectors V20 to V23 in an area where addresses are consecutive in the memory 7. As described above, the calculator 1 folds back the information vectors V20 to V23 in accordance with the size of the sub-register 5 and sequentially arranges the folded information vectors in the memory 7.

Each of the pieces of data V20a, V21a, V22a, and V23a and the pieces of data V20b, V21b, V22b, and V23b is an example of a sub-vector group. Each of the pieces of data V20c, V21c, V22c, and V23c and the pieces of data V20d, V21d, V22d, and V23d is an example of a sub-vector group. The operation processing device 2 may read the information vectors V20 to V23 from the memory 7 in parallel in units of sub-vector groups.

For example, it is assumed that the operation processing device 2 fetches a load instruction in which a source address of a transfer source is Aa and a transfer destination is the register 4a. In this case, the operation processing device 2 stores the pieces of data V1a, V1b, V1c, and V1d of the seed vector V1 in the sub-registers 5a, 5b, 5c, and 5d of the register 4a, respectively. It is assumed that the operation processing device 2 fetches a load instruction in which a source address of a transfer source is Ab and a transfer destination is the register 4b. In this case, the operation processing device 2 stores the data V20a of the information vector V20 and the data V21a of the information vector V21 in the sub-registers 5a and 5b of the register 4b, respectively. The operation processing device 2 stores the data V22a of the information vector V22 and the data V23a of the information vector V23 in the sub-registers 5c and 5d of the register 4b, respectively.

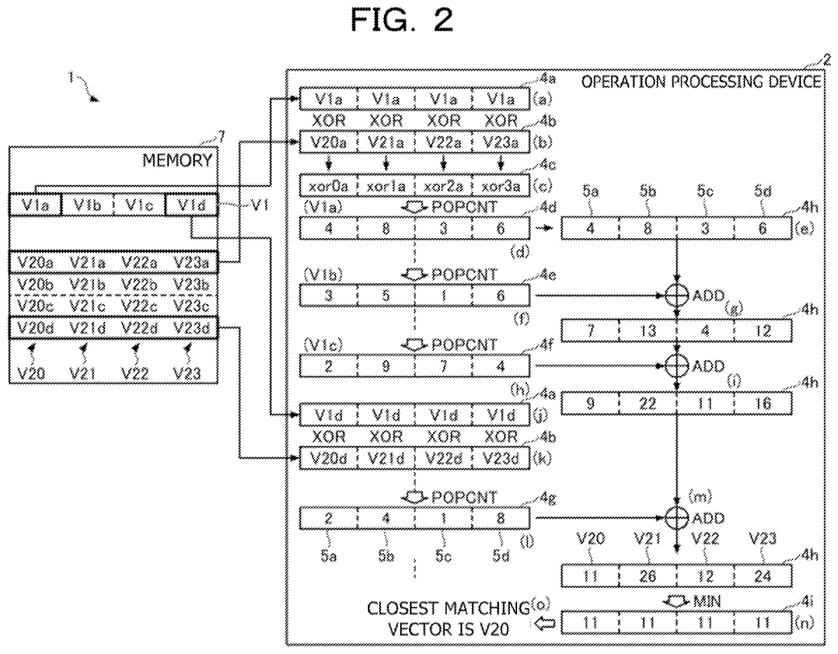

FIG. 2 is an explanatory diagram illustrating an example of an action of the calculator 1 in FIG. 1. FIG. 2 illustrates an example in which a closest matching vector closest to the seed vector V1 among the information vectors V20 to V23 is searched. An action illustrated in FIG. 2 is an example of a calculation method of the calculator 1, and is realized by the operation processing device 2 executing a search program for the closest matching vector. Unless otherwise specified, operation instructions for executing arithmetic operations and logical operations included in the search program are SIMD operation instructions, and the pieces of data held in the sub-registers 5a and 5d are processed in parallel.

First, the operation processing device 2 broadcasts the data V1a of the seed vector V1 to the sub-registers 5a, 5b, 5c, and 5d of the register 4a ((a) of FIG. 2). A process of broadcasting the data V1a to the sub-registers 5a, 5b, 5c, and 5d of the register 4a is an example of a first process. The register 4a to which the data V1a is transferred is an example of a first register.

Subsequently, the operation processing device 2 transfers the pieces of data V20a, V21a, V22a, and V23a of the information vectors V20 to V23 to the sub-registers 5a, 5b, 5c, and 5d of the register 4b ((b) of FIG. 2). A process of transferring the pieces of data V20a, V21a, V22a, and V23a to the sub-registers 5a, 5b, 5c, and 5d of the register 4b is an example of a second process. The register 4b to which the pieces of data V20a, V21a, V22a, and V23a are transferred is an example of a second register.

Subsequently, the operation processing device 2 calculates exclusive ORs xor0a, xor1a, xor2a, and xor3a of the bits of the pieces of data held in the sub-registers 5 of the registers 4a and 4b, and stores the exclusive ORs in the register 4c ((c) of FIG. 2). For example, a bit having a logical value of 1 in the exclusive OR xor0a indicates a bit in which bit values are different from each other in the data V1a of the seed vector V1 and the data V20a of the information vector V20. A bit having a logical value of 1 in the exclusive OR xor1a indicates a bit in which bit values are different from each other in the data V1a of the seed vector V1 and the data V21a of the information vector V21.

Subsequently, the operation processing device 2 executes a POPCNT instruction for calculating the number of bits having a logical value of 1 in each sub-register 5, and stores the execution result in the register 4d ((d) of FIG. 2). By executing the POPCNT instruction, the numbers of bits in which bit values are different from each other are calculated in the data V1a of the seed vector V1 and the pieces of data V20a to V23a of the information vectors V20 to V23. Hereinafter, the number of bits in which bit values are different from each other is also referred to as the number of different bits. The number of different bits is an example of the number of mismatches. According to the example illustrated in FIG. 2, it is assumed that the numbers of different bits between the data V1a and the pieces of data V20a to V23a are “4”, “8”, “3”, and “6”, respectively.

Subsequently, the operation processing device 2 stores the numbers of different bits held in the register 4d in the register 4h ((e) of FIG. 2). Storing of the numbers of different bits held in the register 4d in the register 4h may be executed by, for example, adding (integrating) the values of the sub-registers of the register 4h initialized to “0” and the values of the sub-registers of the register 4d. A process of calculating the exclusive OR, a process of calculating the number of bits having the logical value of 1, and a process of integrating the values of the sub-registers of the register 4h and the values of the sub-registers of the register 4d are an example of a third process.

Thereafter, the operation processing device 2 repeatedly executes processes similar to the processes in (a) of FIG. 2 to (d) of FIG. 2 on all other pieces of data V1b, V1c, and V1d of the seed vector V1. For example, the operation processing device 2 broadcasts the data V1b to the sub-registers 5a, 5b, 5c, and 5d of the register 4a. The operation processing device 2 calculates the numbers of different bits “3”, “5”, “1”, and “6” between the data V1b and the pieces of data V20b, V21b, V22b, and V23b of the information vectors V20 to V23, and stores the numbers of different bits in the register 4e ((f) of FIG. 2). Subsequently, the operation processing device 2 adds the pieces of data held in the sub-registers 5a to 5d of the registers 4h and 4e by an addition instruction ADD, and overwrites the register 4h ((g) of FIG. 2).

The operation processing device 2 broadcasts the data V1c to the sub-registers 5a, 5b, 5c, and 5d of the register 4a. The operation processing device 2 calculates the numbers of different bits “2”, “9”, “7”, and “4” between the data V1c and the pieces of data V20c, V21c, V22c, and V23c of the information vectors V20 to V23, and stores the numbers of different bits in the register 4f ((h) of FIG. 2). Subsequently, the operation processing device 2 adds the pieces of data held in the sub-registers 5a to 5d of the registers 4h and 4f by an addition instruction ADD, and overwrites the register 4h ((I) of FIG. 2).

The operation processing device 2 broadcasts the data V1d to the sub-registers 5a, 5b, 5c, and 5d of the register 4a ((j) of FIG. 2). The operation processing device 2 loads the pieces of data V20d, V21d, V22d, and V23d of the information vectors V20 to V23 into the sub-registers 5a, 5b, 5c, and 5d of the register 4b ((k) of FIG. 2).

Subsequently, after the exclusive ORs of the pieces of data held in the sub-registers 5 of the registers 4a and 4b are calculated, the operation processing device 2 calculates the numbers of different bits “2”, “4”, “1”, and “8”, and stores the numbers of different bits in the register 4g ((I) of FIG. 2). Subsequently, the operation processing device 2 adds the pieces of data held in the sub-registers 5a to 5d of the registers 4h and 4g by an addition instruction ADD, and overwrites the register 4h ((m) of FIG. 2). A value held in each of the sub-registers 5a to 5d of the register 4h indicates an integrated value of a total number of different bits of the corresponding one of the information vectors V20, V21, V22, and V23. The registers 4d, 4e, 4f, and 4g in which integrated values of the numbers of different bits of the information vectors V20, V21, V22, and V23 are stored, respectively, are an example of a third register. The register 4h in which integrated values of total numbers of different bits of the information vectors V20, V21, V22, and V23 are stored is an example of a fourth register.

Subsequently, the operation processing device 2 calculates a minimum value (MIN) of the integrated values of the numbers of different bits held in the sub-registers 5a to 5d of the register 4h, and stores the minimum value in all the sub-registers 5a to 5d of the register 4i ((n) of FIG. 2). In the example illustrated in FIG. 2, the minimum value is “11”. The operation processing device 2 compares the pieces of data held in the sub-registers 5a to 5d of the register 4i with the pieces of data held in the sub-registers 5a to 5d of the register 4h, and determines that the minimum value of the numbers of different bits corresponds to the information vector V20. The operation processing device 2 determines that the closest matching vector closest to the seed vector V1 is the information vector V20 ((o) of FIG. 2).

As described above, in this embodiment, the calculator 1 folds back the information vectors V20 to V23 in accordance with the size of the sub-register 5 and arranges the folded information vectors in the memory 7. For example, the calculator 1 calculates and integrates the numbers of different bits between the data V1a of the seed vector V1 broadcasted to the sub-registers 5 of the register 4a and the pieces of data V20a, V21a, V22a, and V23a stored in the sub-registers 5 of the register 4b.

Accordingly, the calculator 1 does not execute an addition process between the sub-registers 5 in the SIMD register 4 except for the POPCNT instruction. For example, addition of partial integrated values of the information vectors V2 is executed by using an addition instruction ADD between different SIMD registers 4. Accordingly, the number of clock cycles taken for the search for the closest matching vector may be reduced as compared with a case where the addition process between the sub-registers 5 in the SIMD register 4 is frequently used. As a result, search efficiency for the closest matching vector may be improved, and a search time may be shortened.

The operation processing device 2 holds, in the SIMD registers 4d, 4e, 4f, and 4g, the numbers of different bits between the sub-vector that is a part of the information vectors V20 to V23 and the sub-vector that is a part of the seed vector V1, respectively, and adds the numbers of different bits to the SIMD register 4h. Accordingly, the numbers of different bits of the information vectors V20 to V23 may be integrated by using the addition instruction ADD between different SIMD registers 4 without frequently using the addition process between the sub-registers 5 in the SIMD register 4.

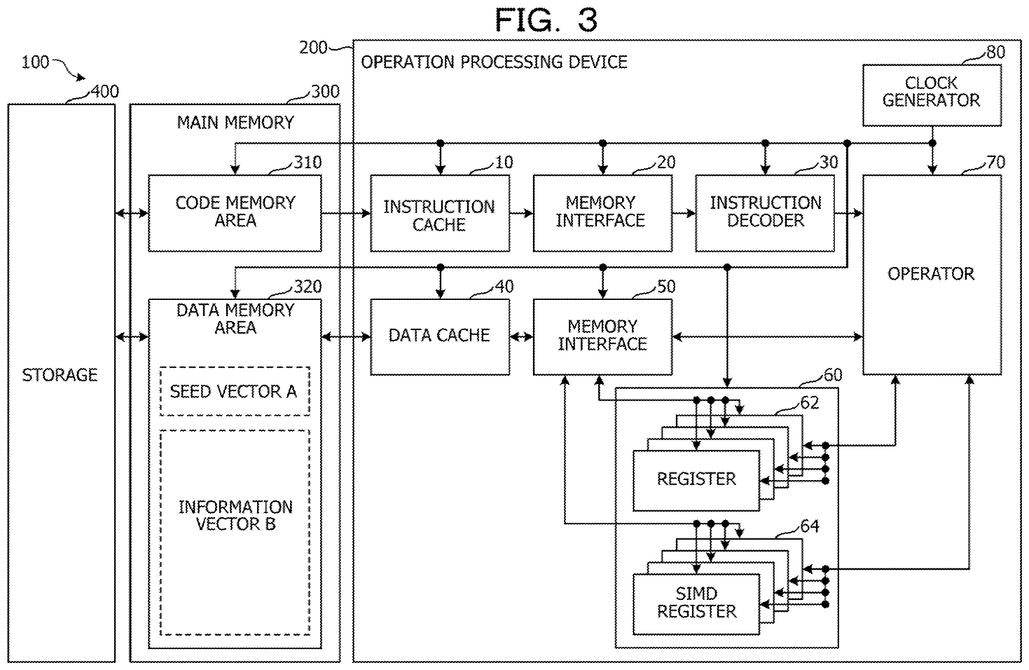

FIG. 3 illustrates an example of a calculator according to another embodiment. Detailed description of elements and actions similar to the elements and actions of the above-described embodiment are omitted. A calculator 100 illustrated in FIG. 3 includes an operation processing device 200, a main memory 300, and a storage 400. For example, the calculator 100 may be an information processing apparatus such as a server or may be a mainframe, a supercomputer, or the like. The storage 400 may be disposed outside the calculator 100.

The operation processing device 200 includes an instruction cache 10, a memory interface 20, an instruction decoder 30, a data cache 40, a memory interface 50, a register file 60, an operator 70, and a clock generator 80. The register file 60 includes a plurality of registers 62 and a plurality of SIMD registers 64. The main memory 300 includes a code memory area 310 for storing an instruction code and a data memory area 320 for storing a seed vector A and a plurality of information vectors B.

The instruction cache 10 may store a part of the instruction code stored in the code memory area 310. When an instruction code to be decoded is stored in the instruction cache 10, the memory interface 20 reads the instruction code to be decoded from the instruction cache 10 and outputs the read instruction code to the instruction decoder 30. When an instruction code to be decoded is not stored in the instruction cache 10, the memory interface 20 reads the instruction code to be decoded from the main memory 300, outputs the instruction code to the instruction decoder 30, and stores the read instruction code in the instruction cache 10.

A part of the seed vector A and the information vectors B stored in the data memory area 320 may be stored in the data cache 40. When data to be read is stored in the data cache 40, the memory interface 50 reads the data to be read from the data cache 40 and outputs the read data to the register file 60. When data to be read is not stored in the data cache 40, the memory interface 50 reads the data to be read from the main memory 300, outputs the read data to the register file 60, and stores the read data in the data cache 40.

The data cache 40 having a large storage capacity may be disposed outside the operation processing device 200, and all pieces of data of the seed vector A and the information vectors B for use in the search for the closest matching vector may be held in the data cache 40.

For example, in the data cache 40, a cache line size, which is a unit for reading and writing data from and to the main memory 300, is 256 bits. The memory interface 50 may read and write 256-bit data from and to the SIMD register 64 in one clock cycle. Since a process of writing data from the register file 60 to the data cache 40 is not described in this embodiment, the description of a data write operation is omitted.

Each register 62 has, for example, a 64-bit width, and is accessed by the memory interface 50 or the operator 70. Each SIMD register has, for example, a 256-bit width, and is accessed by the memory interface 50 or the operator 70. For example, the operator 70 may read and write 256-bit data from and to the SIMD register 64 in one clock cycle.

The operator 70 acts based on an instruction decoded by the instruction decoder 30, and executes an arithmetic operation, a logical operation, and register access. For example, when a SIMD operation instruction is executed as an arithmetic operation or a logical operation, the operator 70 may access the SIMD register 64 in units of 256 bits. Based on a clock (not illustrated) supplied from the outside of the operation processing device 200, the clock generator 80 generates a clock for operating the operation processing device 200 and outputs the generated clock to a clock synchronization circuit such as the operator 70 and the main memory 300.

Hereinafter, for the sake of simplification in description, it is assumed that data to be transferred to each SIMD register 64 is read from the main memory 300. When the seed vector A and the information vectors B may be held in the data cache 40, the data to be transferred to each SIMD register 64 may be read from the data cache 40. In this case, the data memory area 320 in the following description may be replaced with the data cache 40.

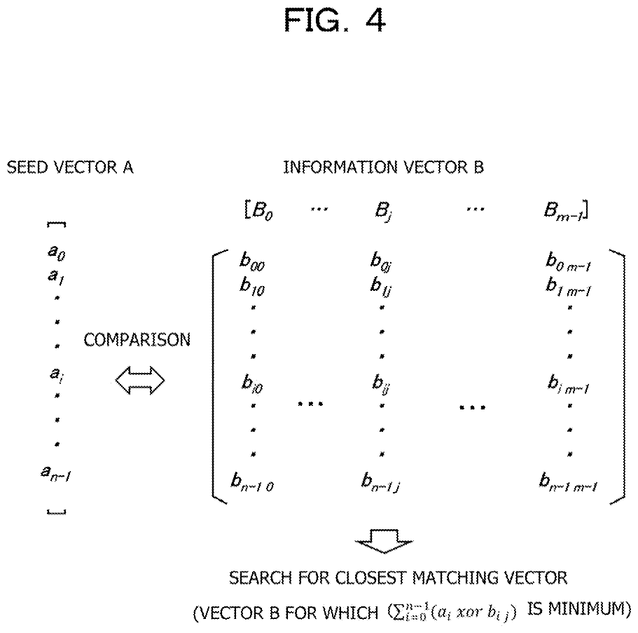

FIG. 4 illustrates an overview of the search for the closest matching vector by the calculator 100 in FIG. 3. The calculator 100 compares each of bits a0, a1, . . . , and an-1 of an n-bit seed vector A with each of bits (for example, b0j, b1j, . . . , and bn-1j) of each of m n-bit information vectors B0 to Bm-1. For example, the calculator 100 executes an exclusive OR operation xor for each bit of the seed vector A and each information vector B, and calculates a total sum (the number of bits) of bits for which the result of the exclusive OR operation xor is a logical value of 1. The logical value of 1 which is the result of the exclusive OR operation xor indicates that logical values of bits in the seed vector A and each information vector B are different from each other. The calculator 100 determines that the information vector B in which the number of bits having the logical value of 1 is the minimum is the closest matching vector closest to the seed vector A.

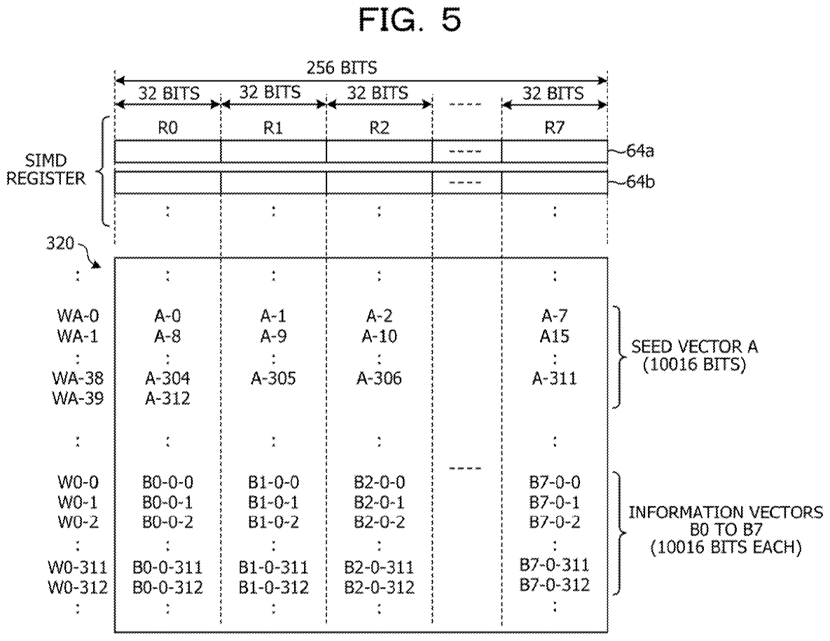

FIG. 5 illustrates an example of the SIMD register 64 in FIG. 3 and data held in the data memory area 320. Each of the SIMD registers 64 (64a, 64b, . . . ) includes eight 32-bit sub-registers R (R0, R1, R2, . . . , and R7).

For example, a seed vector A of 10016 bits and eight information vectors B0 to B7 of 10016 bits are stored in the data memory area 320. Bit lengths of the seed vector A and the information vectors B are not limited to 10016 bits, and the number of information vectors B stored in the data memory area 320 is not limited to eight. A method for arranging the seed vector A and the information vectors B in the data memory area 320 is similar to the method in the above-described embodiment (FIG. 1).

The calculator 100 arranges the seed vector A by 256 bits at consecutive addresses WA-0 to WA-39 allocated to the data memory area 320. 256-bit data corresponding to each address WA includes eight pieces of 32-bit data A (for example, pieces of data A-0, A-1, . . . , and A-7) corresponding to the sub-registers R of the SIMD registers 64. The calculator 100 arranges only final data A-312 at the address WA-39.

The information vectors B0 and B7 are held at addresses W0-0 to W0-312 by 32 bits so as to correspond to the sub-registers R0 and R7, respectively. Accordingly, the operation processing device 200 in FIG. 3 may simultaneously acquire 32 bits of eight information vectors B0 to B7 by one read access to the data memory area 320.

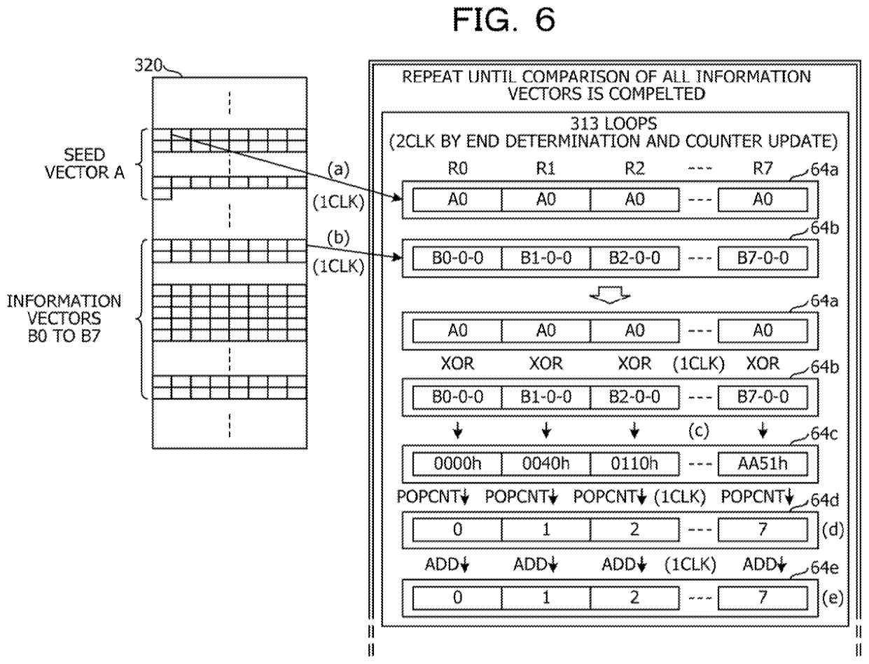

FIGS. 6 to 9 illustrate an example in which the closest matching vector is searched by the calculator 100 in FIG. 3. An action illustrated in FIGS. 6 to 9 is an example of a calculation method of the calculator 100, and is realized by the operation processing device 200 executing a search program for the closest matching vector. SIMD operation instructions are used to execute the search program. In FIGS. 6 to 8, “1CLK”, “2CLK”, and the like indicate the number of clock cycles taken to execute the action. However, a clock cycle taken for memory access is not included in the number of clock cycles. Hereinafter, the SIMD register 64 is also simply referred to as the register 64.

FIG. 6 illustrates an action of calculating the numbers of different bits between 32-bit data A0 of the seed vector A and pieces of 32-bit data B*-0-0 of the eight information vectors B. A symbol*indicates any one of “0” to “7”. First, the operation processing device 200 broadcasts the data A-0 of the seed vector A to the sub-registers R0 to R7 of the register 64a ((a) of FIG. 6). A process of broadcasting the data A0 of the seed vector A to the sub-registers R0 to R7 of the register 64a is an example of a first process. Subsequently, the operation processing device 200 loads the pieces of data B0-0-0, B1-0-0, . . . , and B7-0-0 of the information vectors B0 to B7 into the sub-registers R0 to R7 of the register 64b ((b) of FIG. 6). The register 64a is an example of a first register, and the register 64b is an example of a second register. A process of loading the pieces of data B0-0-0, B1-0-0, . . . , and B7-0-0 of the information vectors B0 to B7 into the sub-registers R0 to R7 of the register 64b is an example of a second process.

Subsequently, the operation processing device 200 executes an exclusive OR operation XOR of the pieces of data held in the sub-registers R0 to R7 of the registers 64a and 64b and stores the execution result in the register 64c ((c) of FIG. 6). In the example illustrated in FIG. 6, “0000 h”, “0040 h”, “0110 h”, and “AA51 h” (h indicates a hexadecimal number) are stored in the sub-registers R0, R1, R2, and R7 of the register 64c, respectively.

Subsequently, the operation processing device 200 executes the POPCNT instruction for calculating the number of bits having the logical value of 1 in each of the sub-registers R0 to R7, and stores the operation result in the register 64d ((d) of FIG. 6). In the example illustrated in FIG. 6, the numbers of different bits between the data A0 of the seed vector A and the pieces of data B0-0-0, B1-0-0, B2-0-0, . . . , and B7-0-0 of the information vectors B0, B1, B2, . . . , and B7 are “0”, “1”, “2”, . . . , and “7”, respectively. The register 64d is an example of a third register.

Subsequently, the operation processing device 200 executes an addition instruction ADD for adding the value of each sub-register R in the register 64d and the value of each sub-register R in the register 64e, and stores the operation result in each sub-register R in the register 64e ((e) of FIG. 6). An initial value of the register 64e is “0”. The register 64e is an example of a fourth register. A process of executing the exclusive OR operation XOR, a process of calculating the numbers of bits having the logical value of 1, and a process of integrating the values of the sub-registers of the register 64d into the sub-registers of the register 64e are an example of a third process.

By looping the action illustrated in FIG. 6 313 times, the operation processing device 200 calculates the number of different bits corresponding to each of the pieces of data A0 to A312 of the seed vector A, and integrates the calculated number of different bits by using the sub-registers R0 to R7 of the register 64e. As a result, the numbers of different bits among the 10016 bits of the information vectors B0 to B7 are stored in the sub-registers R0 to R7 of the register 64e. Seven clock cycles including two clock cycles taken for the update of a counter and the determination of the end of the loop are taken for one calculation of the numbers of different bits of 32 bits of the information vectors B0 to B7 illustrated in FIG. 6. Thus, 2191 clock cycles in 313 loops are taken for the calculation of the number of different bits of 10016 bits for each of the information vectors B0 to B7.

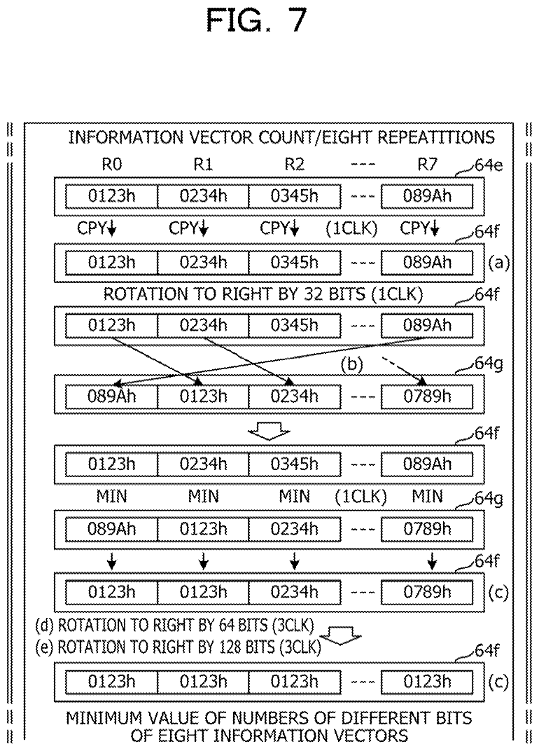

Subsequently, in FIG. 7, the operation processing device 200 calculates the minimum value among the numbers of different bits of the information vectors B0 to B7 calculated in FIG. 6. First, the operation processing device 200 copies (CPY) the value of the register 64e to the register 64f ((a) of FIG. 7). It is assumed that the numbers of different bits among 10016 bits of the information vectors B0 to B7 calculated in FIG. 6 are 0123 h, 0234 h, 0345 h, 0456 h, 0567 h, 0678 h, 0789 h, and 089 Ah. The register 64f is an example of a fifth register.

Subsequently, the operation processing device 200 rotates the pieces of data held in the register 64f to the right by 32 bits and stores the rotation result in the register 64g ((b) of FIG. 7). The register 64g is an example of a sixth register. Subsequently, the operation processing device 200 executes a minimum value operation instruction MIN between the numbers of different bits of 32 bits held in the sub-registers R0 to R7 of the register 64f and the numbers of different bits of rotated 32 bits held in the sub-registers R0 to R7 of the register 64g. The operation processing device 200 stores the operation result in the register 64f ((c) of FIG. 7).

Subsequently, the operation processing device 200 rotates the pieces of data held in the register 64f to the right by 64 bits and stores the rotation result in the register 64g ((d) of FIG. 7). Subsequently, the operation processing device 200 executes a minimum value operation instruction MIN between the numbers of different bits of 32 bits held in the sub-registers R0 to R7 of the register 64f and the numbers of different bits of rotated 32 bits held in the sub-registers R0 to R7 of the register 64g (not illustrated). The operation processing device 200 stores the operation result in the register 64f (not illustrated).

Subsequently, the operation processing device 200 rotates the pieces of data held in the register 64f to the right by 128 bits and stores the rotation result in the register 64g ((e) of FIG. 7). Subsequently, the operation processing device 200 executes a minimum value operation instruction MIN between the numbers of different bits of 32 bits held in the sub-registers R0 to R7 of the register 64f and the numbers of different bits of rotated 32 bits held in the sub-registers R0 to R7 of the register 64g (not illustrated). The operation processing device 200 stores the operation result in the register 64f ((f) of FIG. 7).

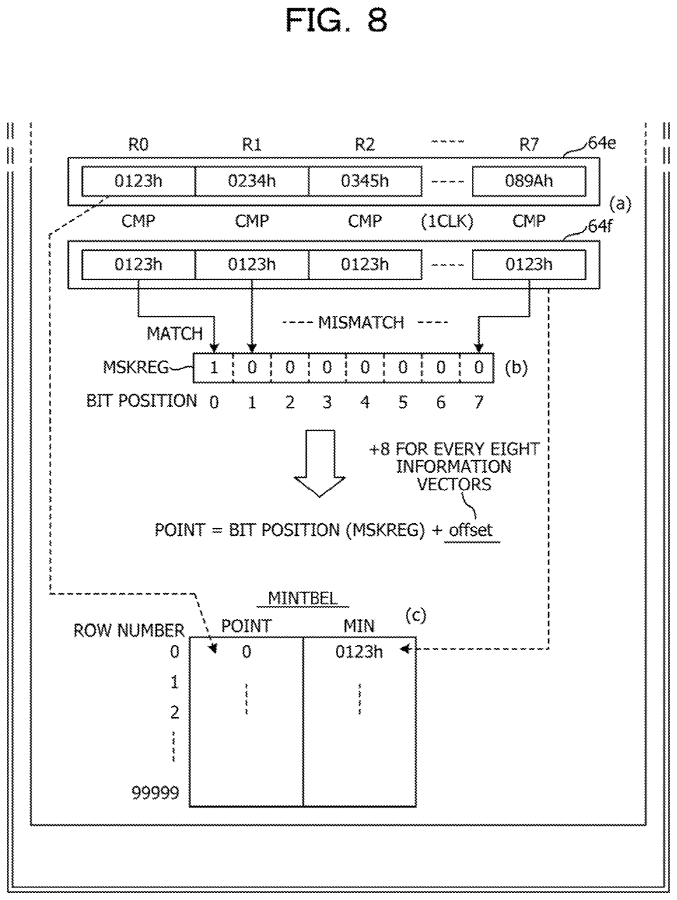

In the example illustrated in FIG. 7, “0123 h” is obtained as a minimum value of the numbers of different bits. However, which of the information vectors B0 to B7 corresponds to the minimum number of different bits “0123 h” is unknown. Accordingly, in FIG. 8, the operation processing device 200 determines which of the information vectors B0 to B7 corresponds to the minimum number of different bits “0123 h”.

In FIG. 8, the operation processing device 200 compares the numbers of different bits of the information vectors B0 to B7 held in the sub-registers R0 to R7 of the register 64e with the minimum numbers of different bits held in the sub-registers R0 to R7 of the register 64f ((a) of FIG. 8). The numbers of different bits are compared by executing a comparison instruction CMP. When the comparison results match, the operation processing device 200 sets a corresponding bit of a mask register MSKREG to “1”, and when the comparison results do not match, the operation processing device 200 resets the corresponding bit of the mask register MSKREG to “0” ((b) of FIG. 8).

The operation processing device 200 stores a pair of a pointer value POINT corresponding to “1” of the mask register MSKREG and the minimum number of different bits MIN in a minimum value table MINTBL ((c) of FIG. 8). The pointer value POINT is a value obtained by adding an offset value offset to a bit position of “1” of the mask register MSKREG. The pointer value POINT is an example of identification information corresponding to the information vector B having the minimum number of different bits MIN. The minimum value table MINTBL is an example of a holding unit.

An initial value of the offset value offset is “0”, and “+8” is added to each of the eight information vectors B. Whenever the minimum numbers of different bits MIN of the eight information vectors B are calculated, the operation processing device 200 stores a pair of the pointer value POINT and the minimum number of different bits MIN in the minimum value table MINTBL. The minimum value table MINTBL may be allocated to a built-in RAM mounted on the operation processing device 200.

For example, a pointer value POINT indicating one of the eight information vectors B0 to B7 acquired in the actions illustrated in FIGS. 6 and 7 and the minimum number of different bits MIN are stored in a zeroth row of the minimum value table MINTBL. A pointer value POINT indicating one of the eight information vectors B8 to B15 and the minimum number of different bits MIN are stored in a first row of the minimum value table MINTBL. In the example illustrated in FIG. 8, the minimum value table MINTBL has an area where 100,000 pairs of pointer values POINT and the minimum numbers of different bits MIN are stored. Accordingly, the operation processing device 200 may compare a maximum of 800,000 information vectors B with the seed vector A and may detect at least one of the information vectors B as the closest matching vector.

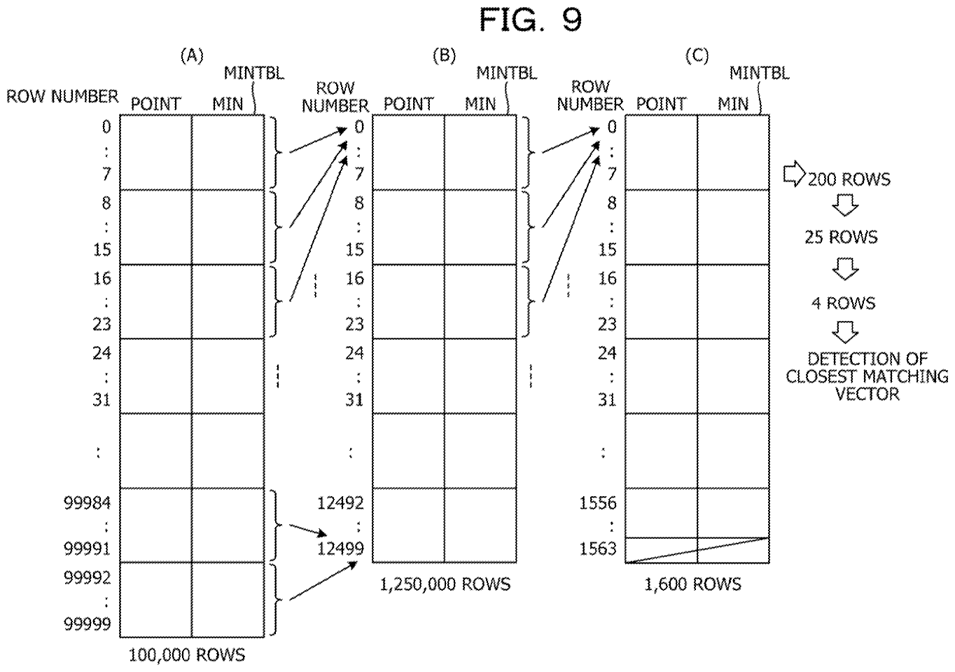

Subsequently, in FIG. 9, the operation processing device 200 executes a process of searching for the closest matching vector based on information stored in the minimum value table MINTBL in FIG. 8. First, in (A) of FIG. 9, for example, the operation processing device 200 obtains the smallest number of different bits among the eight minimum numbers of different bits MIN for every eight rows of the minimum value table MINTBL by the method illustrated in FIG. 7. Accordingly, a size of the minimum value table MINTBL may be compressed to 12,500 rows in (B) of FIG. 9.

Subsequently, for every 8 rows of the minimum table MINTBL in (B) of FIG. 9, the operation processing device 200 obtains the smallest number of different bits among the eight minimum numbers of different bits MIN, and compresses the size of the minimum value table MINTBL to 1,600 rows in (C) of FIG. 9. The operation processing device 200 detects the closest matching vector among the 800,000 information vectors B by repeating a process of obtaining the smallest number of different bits for every 8 rows of the minimum value table MINTBL.

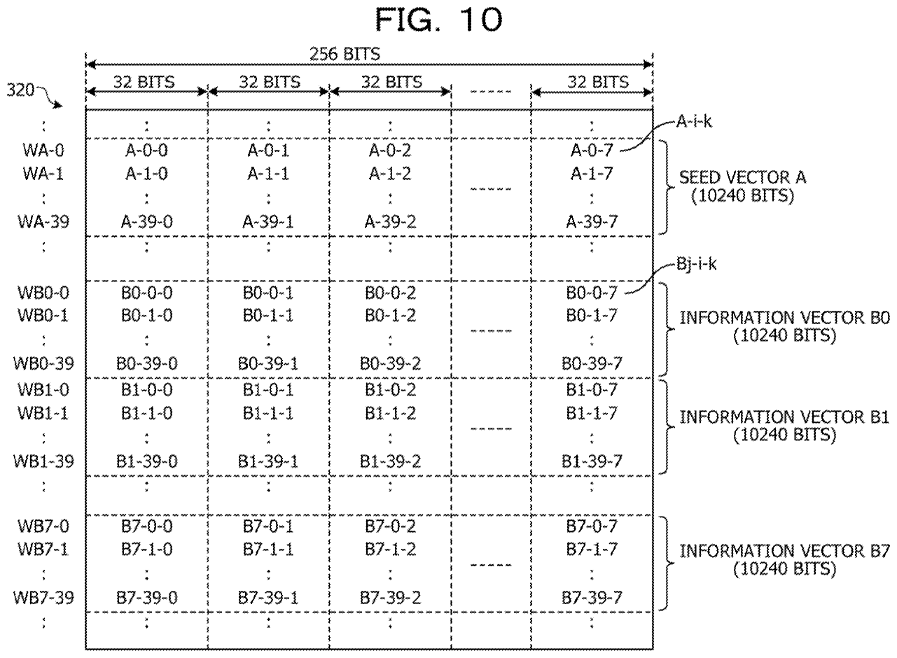

FIG. 10 illustrates another example of data held in the data memory area 320 in FIG. 3. As illustrated in FIG. 10, similarly to the seed vector A, the information vectors B0 to B7 hold 256 bits for every 40 consecutive addresses WB allocated to the data memory area 320. Although the bit lengths of the seed vector A and the information vectors B are 10240 bits in FIG. 10, the bit lengths may be 10016 bits as in FIG. 5.

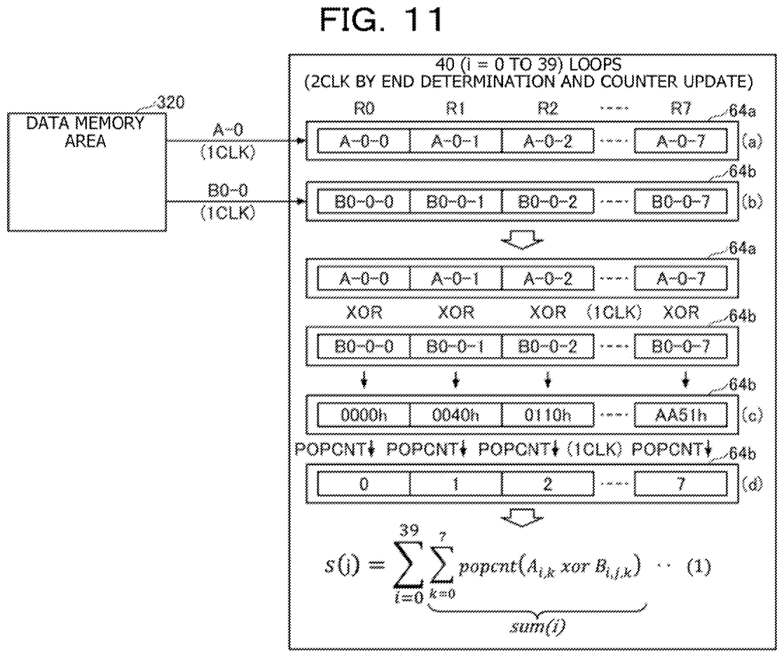

FIG. 11 illustrates an example in which the closest matching vector is searched by using data of an array in FIG. 10. Detailed description will be omitted for the same action as the action illustrated in FIG. 6. First, the operation processing device 200 loads the pieces of data A-0-0 to A-0-7 of the seed vector A into the sub-registers R0 to R7 of the register 64a ((a) of FIG. 11). Subsequently, the operation processing device 200 loads the pieces of data B0-0-0 to B0-0-7 of the information vector B0 into the sub-registers R0 to R7 of the register 64b ((b) of FIG. 11).

Subsequently, the operation processing device 200 executes an exclusive OR operation XOR of the pieces of data held in the sub-registers R0 to R7 of the registers 64a and 64b, and stores the operation result in the register 64b ((c) of FIG. 11). Subsequently, the operation processing device 200 executes a POPCNT instruction, calculates the number of bits having the logical value of 1 in each of the sub-registers R0 to R7 of the register 64b, and stores the calculation result in the register 64b ((d) of FIG. 11). Four clock cycles are taken for one process from (a) of FIG. 11 to (d) of FIG. 11.

As represented by Equation (1) in FIG. 11, the operation processing device 200 repeats the processes in (a) of FIG. 11 to (d) of FIG. 11 and a process of calculating a sum sum(i) of the numbers of different bits stored in the sub-registers R0 to R7 of the register 64b 40 times. Accordingly, the operation processing device 200 calculates a total sum S(j) of the numbers of different bits of one information vector B0. In Equation (1), a reference sign k indicates a number of each of the sub-registers R0 to R7 of the register 64b. A reference sign i indicates a 256-bit information vector B loaded to the register 64b from one address WB of the data memory area 320 in FIG. 10. A reference sign j indicates an identification number of the information vector B.

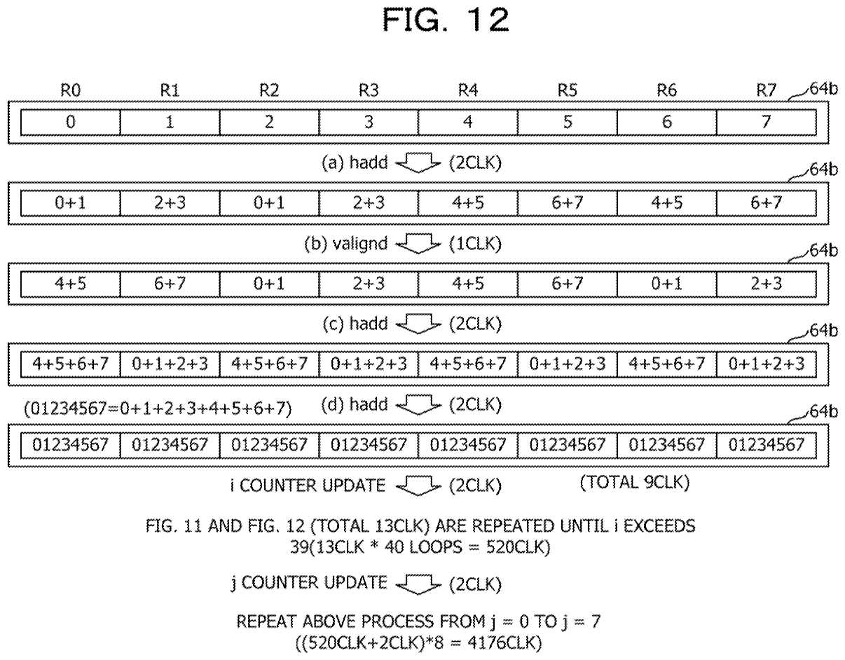

FIG. 12 illustrates an example in which the sum sum(i) in Equation (1) in FIG. 11 is calculated. First, the operation processing device 200 executes an hadd instruction, and adds the eight numbers of different bits held in the register 64b for every two sub-registers R ((a) of FIG. 12). Subsequently, the operation processing device 200 executes a Valignd instruction, rotates the pieces of data held in the register 64b to the right by 64 bits, and replaces the pieces of data of the sub-registers R4 and R5 with the pieces of data of the sub-registers R6 and R7 ((b) of FIG. 12).

Subsequently, the operation processing device 200 executes an hadd instruction, and adds the eight pieces of data held in the register 64b for every two sub-registers R ((c) of FIG. 12). Subsequently, the operation processing device 200 executes an hadd instruction, and adds the eight pieces of data held in the register 64b for every two sub-registers R ((d) of FIG. 12).

Accordingly, the sum sum(i) is held in all the sub-registers R0 to R7 of the register 64b. Nine clock cycles including two clock cycles taken for the update of an i counter and the determination of the end of the loop are taken for the calculation of the sum sum(i). As described above, the number of clock cycles (=“7”) taken for addition between the sub-registers R in the register 64 is larger than the number of clock cycles (=“1”) taken for addition of the sub-registers R between the registers 64.

13 clocks are taken for one process illustrated in FIGS. 11 and 12. Since the processes illustrated in FIGS. 11 and 12 are executed 40 times for every addresses WB in FIG. 10, 520 clock cycles are taken for the calculation of the number of different bits of one information vector B. As a result, 4176 clock cycles are taken for the calculation of the numbers of different bits of the eight information vectors B including the update of a j counter and the determination of the end of the loop. The number of 4176 clock cycles is larger than the number of 2191 clock cycles described with reference to FIG. 6 by 1985 clock cycles (about 1.9 times). For example, the calculation method described with reference to FIG. 6 may obtain the total number of bits of the eight information vectors B with the number of clock cycles that is 52% of the number of clock cycles in the calculation method illustrated in FIGS. 11 and 12.

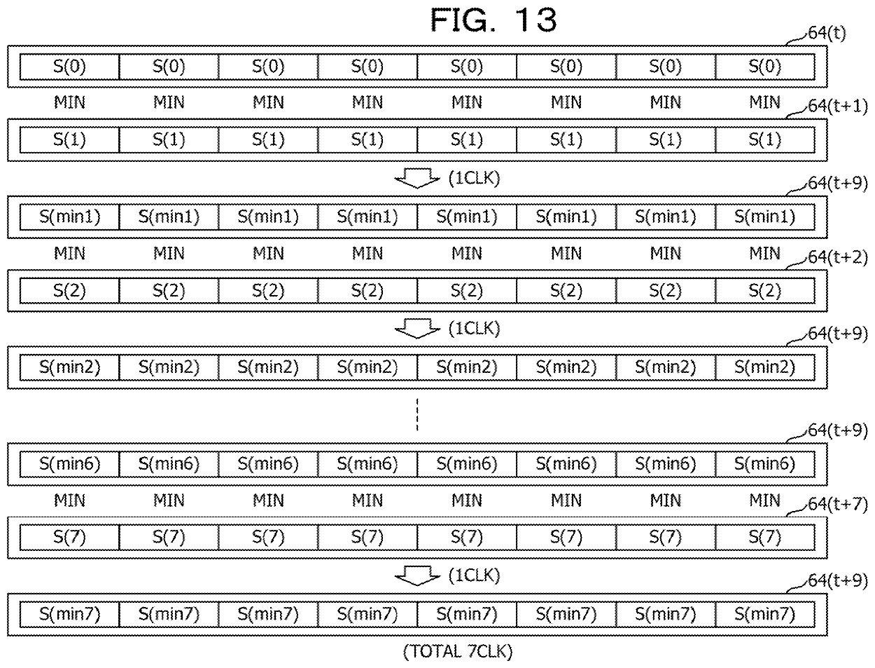

FIG. 13 illustrates an example in which a minimum value of total sums S(0) to S(7) obtained by Equation (1) in FIG. 11 is calculated. A reference sign t for identifying the register 64 for use in the processes in FIG. 13 is an arbitrary integer. First, the operation processing device 200 calculates a minimum value S(min1) of a total sum S(0) of the numbers of different bits of the information vector B0 and a total sum S(1) of the numbers of different bits of the information vector B1. Subsequently, the operation processing device 200 calculates a minimum value S(min2) of the minimum value S(min1) and a total sum S(2) of the numbers of different bits of the information vector B2.

Similarly, the operation processing device 200 calculates a minimum value S(min3) of the minimum value S(min2) and a total sum S(3), a minimum value S(min4) of the minimum value S(min3) and a total sum S(4), and a minimum value S(min5) of the minimum value S(min4) and a total sum S(5). The operation processing device 200 calculates a minimum value S(min6) of the minimum value S(min5) and a total sum S(6) and a minimum value S(min7) of the minimum value S(min6) and a total sum S(7). The operation processing device 200 calculates a minimum value among the total sums S(0) to S(7) as a minimum value S(min7). Seven clock cycles are taken for the calculation of the minimum value S(min7) in FIG. 13.

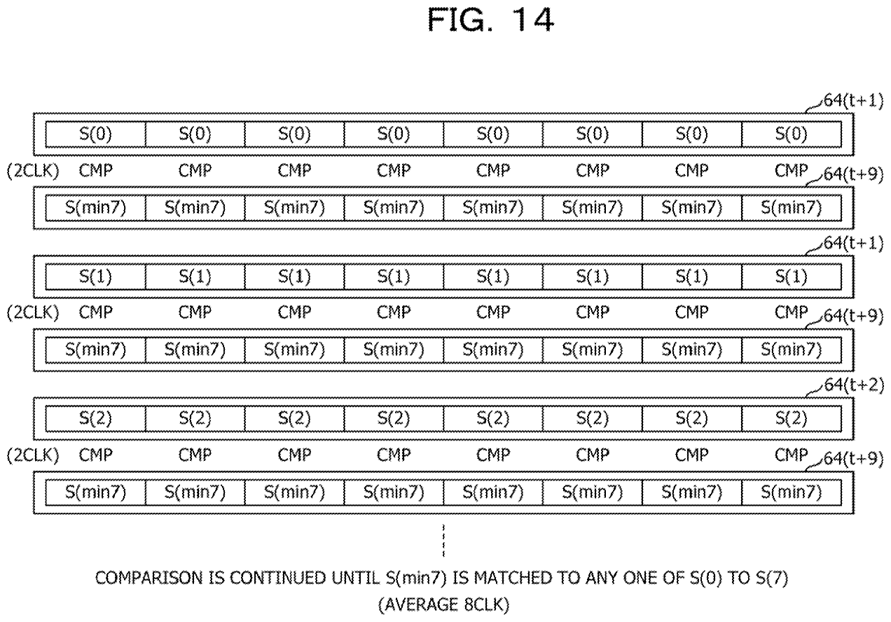

FIG. 14 illustrates an example in which the information vector B corresponding to the minimum number of different bits calculated in FIG. 13 is searched. Until the minimum value S(min7) and the total sums S(0) to S(7) of the information vectors B match with each other, the operation processing device 200 continues the comparison. When it is assumed that the information vector B corresponding to the minimum number of different bits is obtained by four comparisons on average, since one clock cycle is taken for each comparison and update of the counter, eight clock cycles are taken on average.

As described above, in this embodiment, effects similar to the effects in the above-described embodiment may also be obtained. For example, the number of clock cycles taken for the search for the closest matching vector may be reduced as compared with a case where the addition process between the sub-registers R in the SIMD register 64 is frequently used. As a result, search efficiency for the closest matching vector may be improved, and a search time may be shortened.

In this embodiment, as illustrated in FIG. 7, the minimum value among the pieces of data held in the sub-registers R of the SIMD register 64 may be detected by executing the right rotation process and the minimum value operation instruction MIN.

When the number of information vectors B is larger than the number of sub-registers R of the SIMD register 64, the calculator 100 obtains the minimum numbers of different bits for every information vectors B having the same number as the number of sub-registers R. The calculator 100 stores the minimum number of different bits in the minimum value table MINTBL together with the pointer value POINT for identifying the information vector B. Accordingly, the calculator 100 may detect the closest matching vector regardless of the number of information vectors B to be compared with the seed vector A.

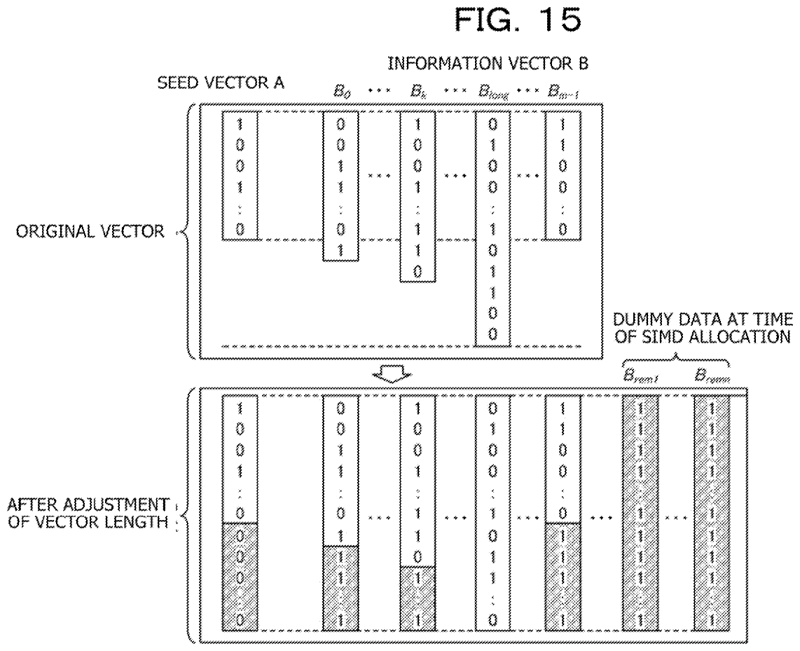

FIG. 15 illustrates an adjustment example in a case where the vector length is variable in a calculator according to another embodiment. A calculator 100 according to this embodiment is similar to the calculator 100 illustrated in FIG. 3 except that a size (bit length or vector length) of at least one of information vectors B is larger than a size of a seed vector A. In this embodiment, it is assumed that the number of information vectors B to be compared with the seed vector A is not divisible by the number (=8) of sub-registers R0 to R7 of a SIMD register 64.

In this case, the calculator 100 executes a process of adding a bit value to at least one of the seed vector A and the information vectors B stored in the data memory area 320 in FIG. 3. For example, the calculator 100 adds a logical value of 0 to the seed vector A in accordance with information vector Blong having a largest bit length, and adds a logical value of 1 opposite to the logical value of 0 to the other information vector B. The logical value of 0 added to the seed vector A is an example of a first logical value, and the logical value of 1 added to the other information vector B is an example of a second logical value.

The bit value added to the seed vector A and the bit value added to the information vector B are set to the logics opposite to each other, and thus, the influence on the determination of the closest matching vector may be suppressed. A maximum bit length to be added is desirably sufficiently shorter than the bit length of the information vector Blong (for example, about 10% or less). Alternatively, the calculator 100 may add the logical value of 1 to the seed vector A and add the logical value of 0 to the other information vector B.

When the number of information vectors B is not divisible by the number of sub-registers R0 to R7 of the SIMD register 64, the calculator 100 adds, as pieces of dummy data, information vectors Brem1 to Bremn to the remaining portion of the sub-register R where the information vector B is not embedded. A logical value of 1 of each bit of the information vectors Brem1 to Bremn is the same as the logical value of 1 added to the above other information vector B.

Accordingly, the calculator 100 may search for the closest matching vector by using all the sub-registers R0 to R7 at all times. Accordingly, the calculator 100 may execute an operation process using the sub-registers R without changing the number of sub-registers R to be used in accordance with the remainder of the sub-registers R. As a result, the search program for the closest matching vector may be simplified as compared with the case where the number of sub-registers R to be used is changed in accordance with the remainder of the sub-registers R.

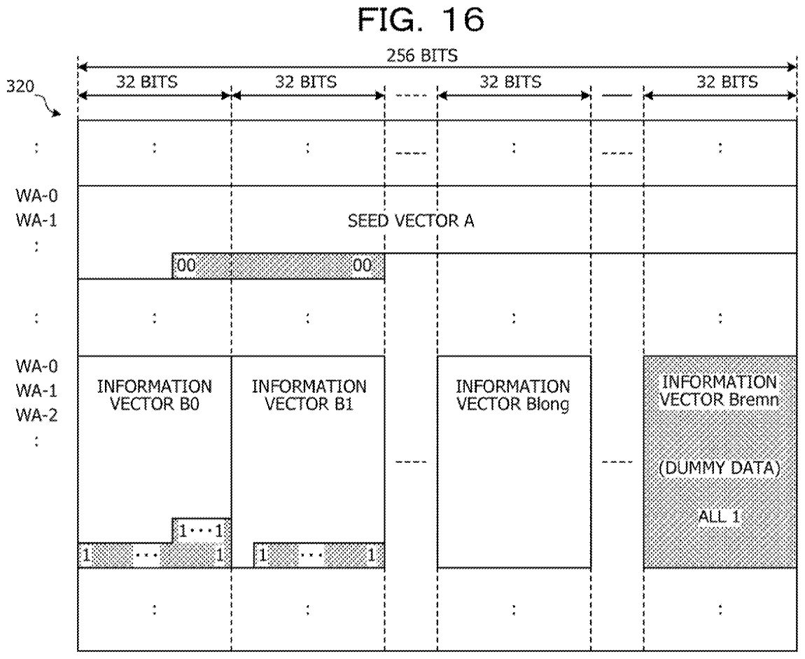

FIG. 16 illustrates an example in which data having an adjusted vector length in FIG. 15 is stored in the data memory area 320. Detailed description is omitted for elements similar to the elements illustrated in FIG. 5. As indicated by shading in FIG. 16, the calculator 100 executes a process of embedding dummy data having a logical value of 1 or a logical value of 0 in the ends of the seed vector A and the other information vector B in accordance with the bit length of the information vector Blong.

As indicated by shading in FIG. 16, the calculator 100 embeds, as the pieces of dummy data, the information vectors Brem1 to Bremn (logical value of 1) in the remaining portion of the sub-registers R where the information vector B is not embedded. As illustrated in FIGS. 6 to 9, the calculator 100 executes a process of searching for the closest matching vector.

As described above, in this embodiment, effects similar to the effects in the above-described embodiment may also be obtained. In this embodiment, when a size of at least one of the information vectors B is larger than a size of the seed vector A, the calculator 100 executes a process of matching the vector lengths by embedding the bit value before the search for the closest matching vector. A process of embedding the information vectors Brem1 to Bremn (logical value of 1) in the remaining portion of the sub-register R where the information vector B is not embedded is executed before the search for the closest matching vector.

Accordingly, the calculator 100 may search for the closest matching vector by the actions illustrated in FIGS. 6 to 9. For example, even when the information vector B is longer than the seed vector A or when there is the sub-register R where the information vector B is not embedded, the calculator 100 may search for the closest matching vector without changing the search program.

The logical value to be embedded in the seed vector A and the logical value to be embedded in the information vector B are set to the logics opposite to each other, and thus, the influence on the determination of the closest matching vector may be suppressed.

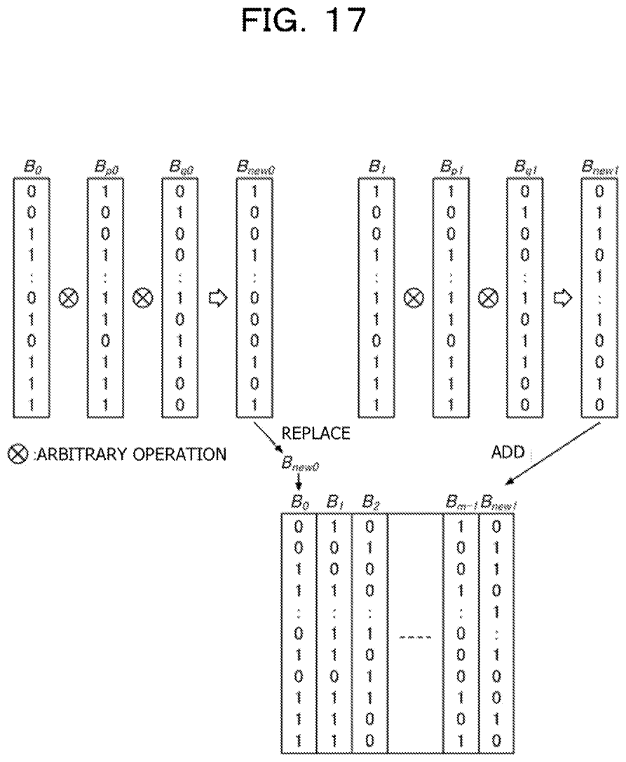

FIG. 17 illustrates an example in which an information vector is updated in a calculator according to another embodiment. A calculator 100 that executes the processes illustrated in FIG. 17 is similar to the calculator 100 illustrated in FIG. 3, and may execute the processes illustrated in FIGS. 6 to 9.

For example, in deep learning, in order to improve a recognition rate at the time of inference, parameters such as weights for use in operation of a neural network are updated. When the calculator 100 uses the closest matching vector for deep learning, there is a case where the information vector B is updated or added as the learning progresses.

In the example illustrated in FIG. 17, the calculator 100 generates a new information vector Bnew0 by executing an arbitrary operation such as a mode or a mean on vector B0, Bp0, and Bq0. The calculator 100 performs the update by replacing the information vector B0 with the information vector Bnew0.

The calculator 100 generates a new information vector Bnew1 by executing an arbitrary operation on the information vectors B1, Bp1, and Bq1. The calculator 100 adds a new information vector Bnew1 to information vector groups B0 to Bm-1.

The update or addition of the information vector B is partially executed. Thus, the calculator 100 may execute an update process or an addition process by partially accessing the information vector B stored in the data memory area 320 illustrated in FIG. 5 without accessing the entire information vector B. Accordingly, even when a plurality of information vectors B are arranged so as to correspond to one address WA as illustrated in FIG. 5, the calculator 100 may execute the update process or the addition process of the information vector B in the same manner as in a case where one information vector B is arranged so as to correspond to one address WA.

The features and advantages of the embodiments are apparent from the above detailed description. The scope of claims is intended to cover the features and advantages of the embodiments described above within a scope not departing from the spirit and scope of right of the claims. Any person having ordinary skill in the art may easily conceive every improvement and alteration. Accordingly, the scope of inventive embodiments is not intended to be limited to that described above and may rely on appropriate modifications and equivalents included in the scope disclosed in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A calculator comprising:
a plurality of registers each including a plurality of sub-registers that hold a plurality of pieces of data for use in operation, respectively;
an operator that executes, in parallel, operations of the pieces of data held in the plurality of sub-registers, respectively; and
a memory that is configured to hold a first vector and a plurality of second vectors to be compared with the first vector,
wherein, each of the plurality of second vectors is divided into sub-vectors each having a size equal to a size of each of the sub-registers, and a plurality of sub-vector groups each including the sub-vectors of the plurality of second vectors are sequentially arranged in a readable manner in the memory in units of sub-vector groups,
a first process of transferring one of sub-vectors of the first vector held in the memory to a plurality of sub-registers of a first register among the plurality of registers, a second process of transferring the sub-vector group of the plurality of second vectors corresponding to the transferred sub-vector of the first vector to a plurality of sub-registers of a second register among the plurality of registers, the sub-vector group being held in the memory, and a third process of calculating and integrating numbers of mismatches between bit values of the sub-vectors held in the sub-registers corresponding to each other in the first register and the second register are repeatedly executed for all sub-vectors of the first vector, and
a second vector in which an integrated value of the calculated numbers of mismatches is smallest is determined to be a closest matching vector.

2. The calculator according to claim 1,
wherein, the numbers of mismatches between the bit values for the respective sub-vectors are stored in corresponding sub-registers of a third register in the third process, and the numbers of mismatches stored in the sub-registers of the third register are integrated in sub-registers of a fourth register, respectively, and
a second vector corresponding to the sub-register of the fourth register that holds a smallest value is determined to be the closest matching vector.

3. The calculator according to claim 2,
wherein, the integrated values of the numbers of mismatches held in the sub-registers of the fourth register are copied in sub-registers of a fifth register,
a process of rotating the values of the sub-registers of the fifth register, storing the rotated values in sub-registers of a sixth register, respectively, and storing small values among the values of the corresponding sub-registers in the fifth register and the sixth register in the sub-registers of the fifth register is repeatedly executed until a same value is held in the sub-registers of the fifth register, and
the value held in the sub-registers of the fifth register is determined to be a minimum value of the integrated values of the numbers of mismatches.

4. The calculator according to claim 1,
wherein, when a number of the second vectors to be compared with the first vector is larger than a number of the sub-registers of the second register, the first process to the third process are executed for every group of the second vector having a number equal to the number of the sub-registers of the second register,
a minimum integrated value among the integrated values calculated for every group is held together with identification information corresponding to the second vector having a minimum integrated value in a holding unit, and
a second vector indicated by the identification information corresponding to the minimum integrated value among the integrated values held in the holding unit is determined to be the closest matching vector.

5. The calculator according to claim 1,
wherein, when a size of at least one of the plurality of second vectors is larger than a size of the first vector,
the size of the first vector is matched to a size of a second vector having a largest size by adding a first logical value to the first vector, and the first vector having the matched size is arranged in the memory, and
a size of an other second vector except for the second vector having the largest size is matched to the size of the second vector having the largest size by adding a second logical value opposite to the first logical value to the other second vector, and the second vector having the matched size is arranged together with the second vector having the largest size in the memory.

6. The calculator according to claim 5,
wherein, when a number of the second vectors is not dividable by a number of the sub-registers of the register, the second logical value is stored in the sub-registers that do not store the sub-vectors of the second vector.

7. A calculation method comprising:
dividing, by a calculator including: a plurality of registers each including a plurality of sub-registers that hold a plurality of pieces of data for use in operation, respectively; an operator that executes, in parallel, operations of the pieces of data held in the plurality of sub-registers, respectively; and a memory that is configured to hold a first vector and a plurality of second vectors to be compared with the first vector, each of the plurality of second vectors into sub-vectors each having a size equal to a size of each of the sub-registers;
sequentially arranging a plurality of sub-vector groups each including the sub-vectors of the plurality of second vectors in a readable manner in the memory in units of sub-vector groups;
repeatedly executing, for all sub-vectors of the first vector, a first process of transferring one of sub-vectors of the first vector held in the memory to a plurality of sub-registers of a first register among the plurality of registers, a second process of transferring the sub-vector group of the plurality of second vectors corresponding to the transferred sub-vector of the first vector to a plurality of sub-registers of a second register among the plurality of registers, the sub-vector group being held in the memory, and a third process of calculating and integrating numbers of mismatches between bit values of the sub-vectors held in the sub-registers corresponding to each other in the first register and the second register; and
determining a second vector in which an integrated value of the calculated numbers of mismatches is smallest to be a closest matching vector.
